(19) United States
(12) Patent Application Publication
(10) Pub. No.: US 2025/0385776 A1
(43) Pub. Date: Dec. 18, 2025

(54) System and Method for Data Communication

(71) Applicant: Taiwan Semiconductor Manufacturing Company, Ltd., Hsinchu (TW)

(72) Inventors: Shenggao Li, Hsinchu (TW); Mu-Shan Lin, Hsinchu (TW); Chien-Chun Tsai, Hsinchu (TW); Cheng-Hsiang Hsieh, Hsinchu (TW); Wei Chih Chen, Hsinchu (TW)

(21) Appl. No.: 18/919,584

(22) Filed: Oct. 18, 2024

Related U.S. Application Data
(60) Provisional application No. 63/660,593, filed on Jun. 17, 2024.

(51) Int. Cl. H04L 7/00

(52) U.S. Cl. CPC H04L 7/0037; H04L 7/0041

(57) ABSTRACT

A system includes a plurality of semiconductor chips that are stacked on top of each other and that include first and second semiconductor chips. The first semiconductor chip includes a clock signal generating circuit, a transmitting circuit, and a receiving circuit. The clock signal generating circuit generates a clock signal and a delayed version of the clock signal. The transmitting circuit transmits a first data signal in response to the clock signal. The receiving circuit receives a second data signal in response to the delayed version of the clock signal. For example, the receiving circuit receives the delayed version of the clock signal at substantially the same time that the transmitting circuit receives the clock signal.

### CROSS-REFERENCE TO RELATED APPLICATION

The present application claims priority to U.S. Provisional Application No. 63/660,593, filed Jun. 17, 2024, the contents of which are incorporated by reference herein in its entirety.

### BACKGROUND

Systems, such as three-dimensional integrated circuit (3D-IC) systems, chip-on-wafer-on-substrate (CoWoS) systems, or other packaging technology systems, involve stacking semiconductor chips on top of each other. This arrangement can enhance performance while reducing the surface area occupied by the semiconductor chips on a package substrate. Proper clock signal synchronization within these semiconductor chips is often important for the optimal performance of such systems.

### BRIEF DESCRIPTION OF THE DRAWINGS

Aspects of the present disclosure are best understood from the following detailed description when read with the accompanying figures:

FIG. 1 is a block diagram of an exemplary system in accordance with embodiments of the present disclosure;

FIG. 2 is a circuit/block diagram of another exemplary system in accordance with embodiments of the present disclosure;

FIG. 3 is a circuit/block diagram of another exemplary system in accordance with embodiments of the present disclosure;

FIG. 4 is a circuit/block diagram of another exemplary system in accordance with embodiments of the present disclosure;

FIG. 5 is a circuit/block diagram of another exemplary system in accordance with embodiments of the present disclosure;

FIG. 6 is a circuit/block diagram of another exemplary system in accordance with embodiments of the present disclosure;

FIG. 7 is a circuit/block diagram of another exemplary system in accordance with embodiments of the present disclosure; and

FIG. 8 is a flowchart illustrating an exemplary method of data communication between semiconductor chips in accordance with embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

In example embodiments, the system comprises first and second semiconductor chips bonded together. In response to a clock signal, the first semiconductor chip transmits and receives data signals to and from the second semiconductor chip and vice versa. The clock signals at the first and second semiconductor chips may not be synchronized. This lack of synchronization can result in data communication errors between the first and second semiconductor chips. Systems and methods as described in certain examples herein mitigate synchronization issues by employing a delay circuit that introduces a predetermined propagation delay to a signal in the system, such as the clock signal. As will be described in detail below, in examples, a delay circuit can help ensure that the clock signal reaches the first and second semiconductor chips at substantially the same time. This synchronization facilitates stable data communication between the first and second semiconductor chips.

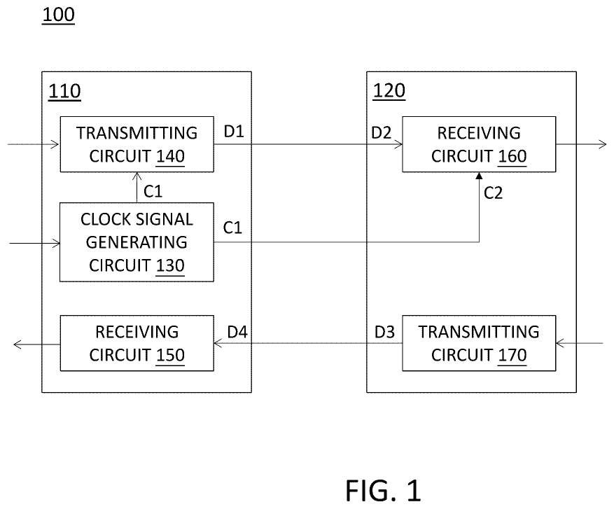

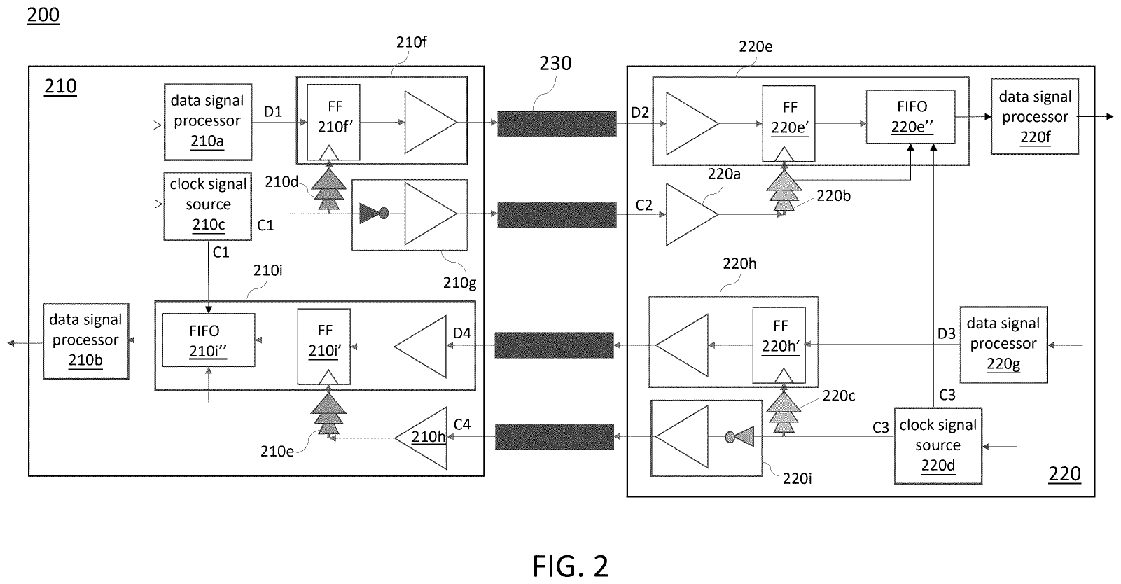

FIG. 1 is a block diagram of an exemplary system 100 in accordance with embodiments of the present disclosure. In certain embodiments, the example system 100, e.g., a three-dimensional integrated circuit (3D-IC) system, a chip-on-wafer-on-substrate (CoWoS) system, or other packaging technology systems, is compliant with a specification for a die-to-die interconnect (and a serial bus) between chiplets, e.g., Universal Chiplet Interconnection Express (UCIE) standard. As illustrated in FIG. 1, the system 100 includes a first semiconductor chip 110 and a second semiconductor chip 120 bonded to the first semiconductor chip 110 through a plurality of interconnects, e.g., interconnects 230 of FIG. 2. Interconnects create electrical connection between the semiconductor chips or between a semiconductor chip and a package substrate, an interposer, or a PCB. Such interconnects include micro-bumps, solder balls, copper pillars, a ball grid array (BGA), a combination of metal and dielectric interconnects, other interconnects created by, e.g., hybrid bonding, tape-automated bonding (TAB), wire bonding, or flip-chip bonding, other suitable interconnects, or combinations thereof.

In some embodiments, the semiconductor chip 110 has a top or bottom surface bonded to a top or bottom surface of the semiconductor chip 120. In other embodiments, an interposer interconnects the semiconductor chips 110, 120. In such other embodiments, the interposer includes an interposer substrate, a front-side redistribution layer (RDL), and one or more through-interposer vias (TIVs). Examples of materials for the interposer substrate include silicon, organic materials, glass, ceramics, polymer-based materials, other suitable interposer substrate materials, and combinations thereof. The front-side RDL is formed over the top surface of the interposer and includes horizontal and vertical metal lines. Each TIV extends from the front-side RDL to the bottom surface of the interposer.

In an alternative embodiment, the interposer further includes a back-side RDL formed over the bottom surface of the interposer. In such an alternative embodiment, the TIV is connected between the front- and back-side RDLs. Examples of materials for the front- and back-side RDLs and the TIVs include copper, nickel, gold, silver, cobalt, tungsten, aluminum, other conductive materials, and combinations thereof.

Each semiconductor chip 110, 120 includes a chip substrate, a chip circuit, and a conductive layer. Examples of materials for the chip substrate include silicon, germanium, III-V semiconductor materials, other suitable semiconductor material, and combinations thereof. The chip circuit is fabricated over the chip substrate and performs one or more circuit functions. The conductive layer (e.g., back end of line or BEOL) interconnects circuit components of the chip circuit. In one example, the circuit components include active circuit components (such as transistors, diodes, and integrated circuits) and passive circuit components (such as resistors, inductors, and capacitors).

In this exemplary embodiment, the semiconductor chip 110 includes a clock signal generating circuit 130, a transmitting circuit 140, and a receiving circuit 150. The clock signal (C1) generating circuit 130 generates a clock signal (C1) and sends the clock signal (C1) as a clock signal (C2) to the semiconductor chip 120. The transmitting circuit 140, in response to the clock signal (C1), transmits the data signal (D1) to the semiconductor chip 120 as a data signal (D2). In some embodiments, the receiving circuit 150, in response to the clock signal (C1), receives a data signal (D4). In other embodiments, the receiving circuit 150 receives the data signal (D4) in response to a delayed version of the clock signal (C1). In such other embodiments, the arrival of the delayed version of the clock signal (C1) at the receiving circuit 150 occurs substantially simultaneously with the arrival of the clock signal (C2) at the semiconductor chip 120. This synchronization facilitates stable data communication between the semiconductor chips 110, 120.

Similarly, the semiconductor chip 120 includes a receiving circuit 160 and a transmitting circuit 170. In some embodiments, the receiving circuit 160, in response to the clock signal (C2), receives the data signal (D2). In such some embodiments, the transmitting circuit 170, in response to the clock signal (C2), transmits a data signal (D3) to the semiconductor chip 110 as a data signal (D4). In other embodiments, the receiving circuit 160 receives the data signal (D2) in response to the clock signal (C2) and another clock signal, e.g., clock signal (C3) of FIG. 2. In such other embodiment, the transmitting circuit 170 transmits the data signal (D3) as a data signal (D4) to the semiconductor chip 110 in response to the clock signal (C3). In certain embodiments, the transmitting circuit 170 transmits the clock signal (C3) to the semiconductor chip 110.

FIG. 2 is a circuit/block diagram of another exemplary system 200 in accordance with embodiments of the present disclosure. As illustrated in FIG. 2, the example system 200, e.g., system 100, includes a first semiconductor chip 210 and a second semiconductor chip 220 bonded to the first semiconductor chip 210 through a plurality of interconnects 230. In this exemplary embodiment, the semiconductor chip 210 includes first and second data signal processors 210a, 210b, a clock signal source 210c, first and second clock trees 210d, 210e, a data signal transmitter 210f, a clock signal transmitter 210g, a clock signal receiver 210h, and a data signal receiver 210i. The data signal processor 210a (e.g., a central processing unit or CPU, a graphics processing unit or GPU, a math co-processor such as a floating-point unit or FPU, a memory device, other devices that process data signals, or combinations thereof) generates a data signal (D1).

The clock signal source 210c generates a clock signal (C1) and, in this exemplary embodiment, includes a phase lock loop (PLL) that adjusts and stabilizes the frequency of the clock signal (C1) based on the frequency of a reference clock signal. The clock tree 210d is connected between the clock signal (C1) source 210b and the data signal (D1) transmitter 210f, distributes the clock signal (C1) to chip circuits (e.g., data signal D1 transmitter 210f) of the semiconductor chip 210, and ensures that the clock signal (C1) reaches the data signal transmitters simultaneously or with minimal skew (i.e., timing differences). The data signal (D1) transmitter 210f transmits the data signal (D1) to the semiconductor chip 220 as a data signal (D2). For example, the data signal (D1) transmitter 210d includes a flip-flop circuit 210f′ and a buffer circuit. In response to the clock signal (C1), the flip-flop circuit 210f′ (e.g., a D-type flip-flop circuit, a JK flip-flop circuit, other suitable flip-flop circuits, or combinations thereof) holds or stores bits of the data signal (D1). Each stored bit is available at the output of the flip-flop circuit 210f′ at the rising (or falling) edge of the clock signal (C1). The buffer circuit of the data signal (D1) transmitter 210f maintains the integrity of the data signal (D1) by amplifying it, providing isolation, reducing noise, and minimizing delays.

The clock signal (C1) transmitter 210g sends the clock signal (C1) as a clock signal (C2) to the semiconductor chip 220. For example, the clock signal (C1) transmitter 210g includes an inverter and a buffer circuit. The inverter generates an inverted version of the clock signal (C1). The buffer circuit of the clock signal (C1) transmitter 210g maintains the integrity of the clock signal (C1) by amplifying it, providing isolation, reducing noise, and minimizing delays.

The clock signal receiver 210h receives a clock signal (C4) from the semiconductor chip 220. For example, the clock signal (C4) receiver 210h includes a buffer circuit that maintains the integrity of the clock signal (C4) by amplifying it, providing isolation, reducing noise, and minimizing delays. The clock tree 210e is connected between the clock signal (C4) receiver 210h and the data signal receiver 210i, distributes the clock signal (C4) to chip circuits (e.g., data signal receiver 210i) of the semiconductor chip 210, and ensures that the clock signal (C4) reaches the data signal receivers simultaneously or with minimal skew (i.e., timing differences).

The data signal receiver 210i receives a data signal (D4) from the semiconductor chip 220. For example, the data signal (D4) receiver 210i includes a buffer circuit, a flip-flop circuit 210i′, and a register circuit 210i″. The buffer circuit of the data signal (D4) receiver 210i maintains the integrity of the data signal (D4) by amplifying it, providing isolation, reducing noise, and minimizing delays. In response to the clock signal (C4), the flip-flop circuit 210i′ (e.g., a D-type flip-flop circuit, a JK flip-flop circuit, other suitable flip-flop circuits, or combinations thereof) holds or stores bits of the data signal (D4). Each stored bit is available at the output of the flip-flop circuit 210i′ at the rising (or falling) edge of the clock signal (C4).

The register circuit 210i″, in response to the clock signals (C1, C4), outputs the bits of the data signal (D4) based on the order they are received thereby. For example, in some embodiments, the register circuit 210i″ is a first in first out (FIFO) register circuit and outputs the bits of the data signal (D4) in the same order they are received. In such some embodiments, the clock signal (C4) controls the writing of the data signal (D4) into the register circuit 210i″, whereas the clock signal (C4) controls the reading of the data signal (D4) from the register circuit 210i″ by the data signal (D4) processor 210b. In this exemplary embodiment, the clock signals (C1, C4) operate in different clock domains. For example, they (C1, C4) have different frequencies, phases, or independent of each other. Various configurations for the register circuit 210i″ are contemplated in other embodiments. The data signal (D4) processor 210b (e.g., a CPU, a GPU, a math co-processor such as an FPU, a memory device, other devices that generate data signals, or combinations thereof) processes the data signal (D4).

Similarly, the semiconductor chip 220 includes a clock signal (C2) receiver 220a, first and second clock trees 220b, 220c, a clock signal source 220d, a data signal (D2) receiver 220e, first and second data signal processors 220f, 220g, a data signal transmitter 220h, and a clock signal (C4) transmitter 220i. The clock signal (C2) receiver 220a receives the clock signal (C2) from the semiconductor chip 210. For example, the clock signal (C2) receiver 220a includes a buffer circuit that maintains the integrity of the clock signal (C2) by amplifying it, providing isolation, reducing noise, and minimizing delays. The clock tree 220b is connected between the clock signal (C2) receiver 220a and the data signal (D2) receiver 220e, distributes the clock signal (C2) to chip circuits (e.g., data signal D2 receiver 220e) of the semiconductor chip 220, and ensures that the clock signal (C2) reaches the data signal receivers simultaneously or with minimal skew (i.e., timing differences).

The clock signal source 220d generates a clock signal (C3) and, in this exemplary embodiment, includes a PLL that adjusts and stabilizes the frequency of the clock signal (C3) based on the frequency of a reference clock signal. The data signal (D2) receiver 220e receives the data signal (D2) from the semiconductor chip 210. For example, the data signal (D2) receiver 220e includes a buffer circuit, a flip-flop circuit 220e′, and a register circuit 220e″. The buffer circuit of the data signal (D2) receiver 220e maintains the integrity of the data signal (D2) by amplifying it, providing isolation, reducing noise, and minimizing delays. In response to the clock signal (C2), the flip-flop circuit 220e′ (e.g., a D-type flip-flop circuit, a JK flip-flop circuit, other suitable flip-flop circuits, or combinations thereof) holds or stores bits of the data signal (D2). Each stored bit is available at the output of the flip-flop circuit 220e′ at the rising (or falling) edge of the clock signal (C3).

The register circuit 220e″, in response to the clock signals (C2, C3), outputs the bits of the data signal (D2) based on the order they are received thereby. For example, in some embodiments, the register circuit 220e″ is a FIFO register circuit and outputs the bits of the data signal (D2) in the same order they are received. In such some embodiments, the clock signal (C2) controls the writing of the data signal (D2) into the register circuit 220e″, whereas the clock signal (C3) controls the reading of the data signal (D2) from the register circuit 220e″ by the data signal (D2) processor 220f. In this exemplary embodiment, the clock signals (C2, C3) operate in different clock domains. For example, they have different frequencies, phases, or independent of each other. Various configurations for the register circuit 220e″ are contemplated in other embodiments. The data signal (D2) processor 220f (e.g., a CPU, a GPU, a math co-processor such as an FPU, a memory device, other devices that generate data signals, or combinations thereof) processes the data signal (D2).

The data signal processor 220g (e.g., a CPU, a GPU, a math co-processor such as an FPU, a memory device, other devices that process data signals, or combinations thereof) generates a data signal (D3). The clock tree 220c is connected between the clock signal (C3) source 220d and the data signal (D3) transmitter 220h, distributes the clock signal (C3) to chip circuits (e.g., data signal D3 transmitter 220h) of the semiconductor chip 220, and ensures that the clock signal (C3) reaches the data signal transmitters simultaneously or with minimal skew (i.e., timing differences). The data signal (D3) transmitter 220h transmits the data signal (D3) to the semiconductor chip 210 as the data signal (D4). For example, the data signal (D3) transmitter 220h includes a flip-flop circuit 220h′ and a buffer circuit. In response to the clock signal (C3), the flip-flop circuit 220h′ (e.g., a D-type flip-flop circuit, a JK flip-flop circuit, other suitable flip-flop circuits, or combinations thereof) holds or stores bits of the data signal (D3). Each stored bit is available at the output of the flip-flop circuit 220h′ at the rising (or falling) edge of the clock signal (C3). The buffer circuit of the data signal (D3) transmitter 220h maintains the integrity of the data signal (D3) by amplifying it, providing isolation, reducing noise, and minimizing delays.

The clock signal (C3) transmitter 220i sends the clock signal (C3) as a clock signal (C4) to the semiconductor chip 210. For example, the clock signal (C3) transmitter 220i includes an inverter and a buffer circuit. The inverter generates an inverted version of the clock signal (C3). The buffer circuit of the clock signal (C3) transmitter 220i maintains the integrity of the clock signal (C3) by amplifying it, providing isolation, reducing noise, and minimizing delays.

In an exemplary operation, the data signal (D1) processor 210a generates a data signal (D1) while the clock signal (C1) source 210c generates a clock signal (C1). The data signal (D1) transmitter 210f, in response to the clock signal (C1), transmits the data signal (D1) to the semiconductor chip 220 as a data signal (D2). At this time, the clock signal (C1) transmitter 210g sends the clock signal (C1) as a clock signal (C2) to the semiconductor chip 220.

Next, the clock signal (C3) source 220d generates a clock signal (C3). The data signal (D2) receiver 220e, in response to the clock signals (C2, C3), receives the data signal (D2). The data signal (D2) processor 220f then processes the data signal (D2). Subsequently, the data signal (D3) processor 220g generates a data signal (D3). In response to the clock signal (C3), the data signal (D3) transmitter 220h transmits the data signal (D3) to the semiconductor chip 210 as a data signal (D4). At this time, the clock signal (C3) transmitter 220i sends the clock signal (C3) as a clock signal (C4) to the semiconductor chip 210. In response to the clock signals (C1, C4), the data signal (D4) receiver 210i receives the data signal (D4). Thereafter, the data signal (D4) processor 210b processes the data signal (D4).

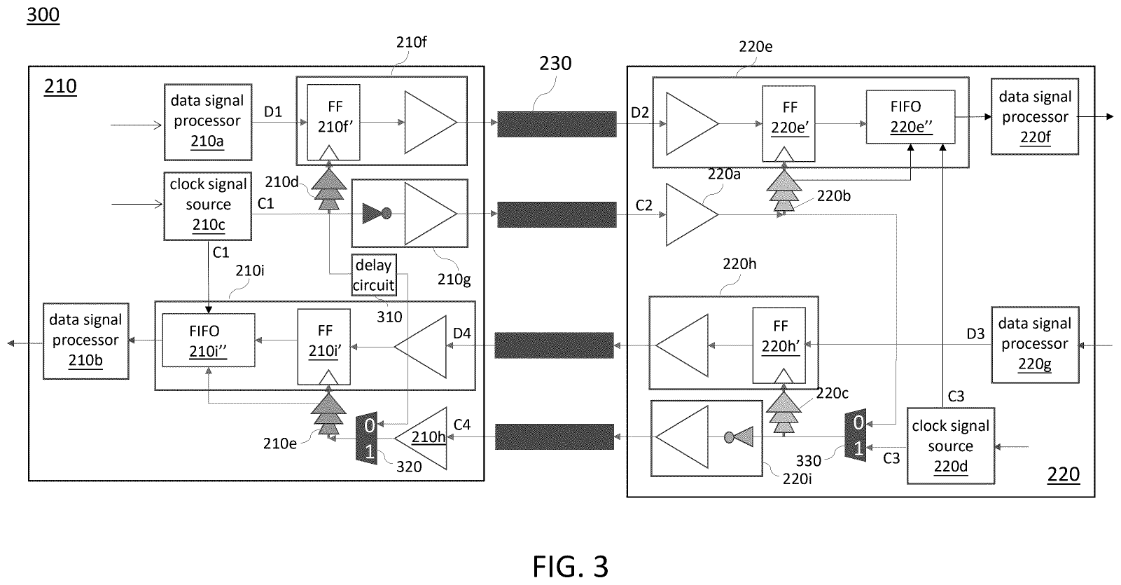

FIG. 3 is a circuit/block diagram of another exemplary system 300 in accordance with embodiments of the present disclosure. As illustrated in FIG. 3, the example system 300, e.g., system 100, differs from the system 200 in that the system 300 further includes a delay circuit 310 and first and second multiplexers 320, 330. The delay circuit 310 is connected between the clock signal source 210c and the multiplexer 320, introduces a propagation delay to the clock signal (C1), and generates a delayed version of the clock signal (C1). For example, the delay circuit 310 mimics the propagation delays of the clock signal (C1) transmitter 210g, the interconnects 230, the clock signal (C2) receiver 220a, the clock signal (C3) transmitter 220i, and the clock signal (C4) receiver 210h. In this exemplary embodiment, the delay circuit 310 includes one or more inverters and/or one or more buffer circuits. Various configurations for the delay circuit 310 are contemplated in other embodiments.

The multiplexer 320, in response to a control signal (e.g., received from a control signal generator), selects one of the delayed version of the clock signal (C1) and the clock signal (C4) and forwards the selected one of the delayed version of the clock signal (C1) and the clock signal (C4) to the data signal (D4) receiver 210i. For example, the multiplexer 320 has a first input terminal connected to the delay circuit 310, a second input terminal connected to the clock signal (C4) receiver 210h, and an output terminal connected to the clock tree 210e. The multiplexer 330, in response to a control signal (e.g., received from a control signal generator), selects one of the clock signals (C2, C3) and forwards the selected one of the clock signals (C2, C3) to the data signal (D3) transmitter 220h. For example, the multiplexer 330 has a first input terminal connected to a node between the clock signal (C2) receiver 220a and the clock tree 220b, a second input terminal connected to the clock signal (C3) source 220d, and an output terminal connected to a node between the clock signal (C3) transmitter 220i and the clock tree 220c.

In an exemplary operation, where the multiplexer 320 selects the delayed version of the clock signal (C1) and the multiplexer 330 selects the clock signal (C2), the data signal (D1) processor 210a generates a data signal (D1) while the clock signal (C1) source 210c generates a clock signal (C1). In response to the clock signal (C1), the data signal (D1) transmitter 210f transmits the data signal (D1) to the semiconductor chip 220 as a data signal (D2). At this time, the clock signal (C1) transmitter 210g sends the clock signal (C1) as a clock signal (C2) to the semiconductor chip 220.

Next, the clock signal (C3) source 220d generates a clock signal (C3). The data signal (D2) receiver 220e, in response to the clock signals (C2, C3), receives the data signal (D2). The data signal (D2) processor 220f then processes the data signal (D2), followed by the data signal (D3) processor 220g generating a data signal (D3). The data signal (D3) transmitter 220h, in response to the clock signal (C2), transmits the data signal (D3) to the semiconductor chip 210 as a data signal (D4). Concurrently, the clock signal (C2) transmitter 220i sends the clock signal (C2) as a clock signal (C4) to the semiconductor chip 210. At this time, the delay circuit 310 generates a delayed version of the clock signal (C1). The data signal (D4) receiver 210i, in response to the clock signal (D1) and the delayed version of the clock signal (C1), receives the data signal (D4). Thereafter, the data signal (D4) processor 210b processes the data signal (D4).

From the above description, by virtue of the delay circuit 310 mimicking the propagation delays introduced by the clock signal (C1) transmitter 210g, the interconnects 230, the clock signal (C2) receiver 220a, the clock signal (C3) transmitter 220i, and the clock signal (C4) receiver 210h, the propagation delay introduced by the delay circuit 310 is substantially equal to the sum of the propagation delays caused by these components 210g, 230, 220a, 220i, 210h. As a result, the arrival of the clock signal (C2) at the data signal (D2) receiver 220e occurs at substantially the same time as the arrival of the delayed version of the clock signal (C1) at the data signal (D4) receiver 210i. This synchronization facilitates stable data communication between the semiconductor chips 210, 220. In certain embodiments, the clock signal (C1) reaches the data signal (D1) transmitter 210f substantially simultaneously with the delayed version of the clock signal (C1) reaches the data signal (D4) receiver 210i.

In another exemplary operation, where the multiplexer 320 selects the clock signal (C4) and the multiplexer 330 selects the clock signal (C3), the data signal (D1) processor 210a generates a data signal (D1), while the clock signal (C1) source 210c generates a clock signal (C1). The data signal (D1) transmitter 210f, in response to the clock signal (C1), transmits the data signal (D1) to the semiconductor chip 220 as a data signal (D2). Meanwhile, the clock signal (C1) transmitter 210g sends the clock signal (C1) as a clock signal (C2) to the semiconductor chip 220.

Subsequently, the clock signal (C3) source 220d generates a clock signal (C3). The data signal (D2) receiver 220e, in response to the clock signals (C2, C3), receives the data signal (D2). The data signal (D2) processor 220f then processes the data signal (D2). Next, the data signal (D3) processor 220g generates a data signal (D3). In response to the clock signal (C3), the data signal (D3) transmitter 220h transmits the data signal (D3) to the semiconductor chip 210 as a data signal (D4). At substantially the same time, the clock signal (C3) transmitter 220i sends the clock signal (C3) as a clock signal (C4) to the semiconductor chip 210. In response to the clock signals (C1, C4), the data signal (D4) receiver 210i receives the data signal (D4). Thereafter, the data signal (D4) processor 210b processes the data signal (D4).

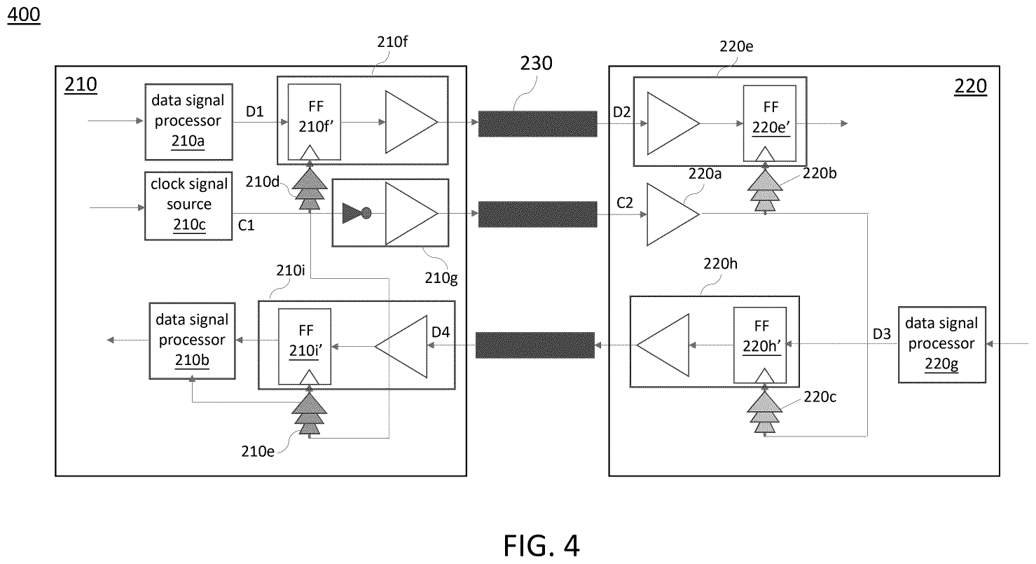

FIG. 4 is a circuit/block diagram of another exemplary system 400 in accordance with embodiments of the present disclosure. As illustrated in FIG. 4, the example system 400, e.g., system 100, differs from the system 200 in that the system 400 is dispensed with (i.e., does not include) the clock signal (C4) receiver 210h, the clock signal (C3) source 220d, and the clock signal (C3) transmitter 220i. The clock signal (C1) source 210c is connected to a node between the clock trees 210d, 210e. The clock signal (C2) receiver 220a is connected to a node between the clock trees 220b, 220c.

In an embodiment, the data signal (D4) receiver 210i is dispensed with the register circuit 210i″. In such an embodiment, the flip-flop circuit 210i′ may be replaced with a demultiplexer.

In an exemplary operation, the data signal (D1) processor 210a generates a data signal (D1) while the clock signal (C1) source 210c generates a clock signal (C1). The data signal (D1) transmitter 210f, in response to the clock signal (C1), transmits the data signal (D1) to the semiconductor chip 220 as a data signal (D2). At this time, the clock signal (C1) transmitter 210g sends the clock signal (C1) as a clock signal (C2) to the semiconductor chip 220.

Next, the data signal (D2) receiver 220e, in response to the clock signal (C2), receives the data signal (D2). The data signal (D3) processor 220g then generates a data signal (D3). The data signal (D3) transmitter 220h, in response to the clock signal (C2), transmits the data signal (D3) to the semiconductor chip 210 as a data signal (D4). In response to the clock signal (C1), the data signal (D4) receiver 210i receives the data signal (D4). Thereafter, the data signal (D4) processor 210b processes the data signal (D4).

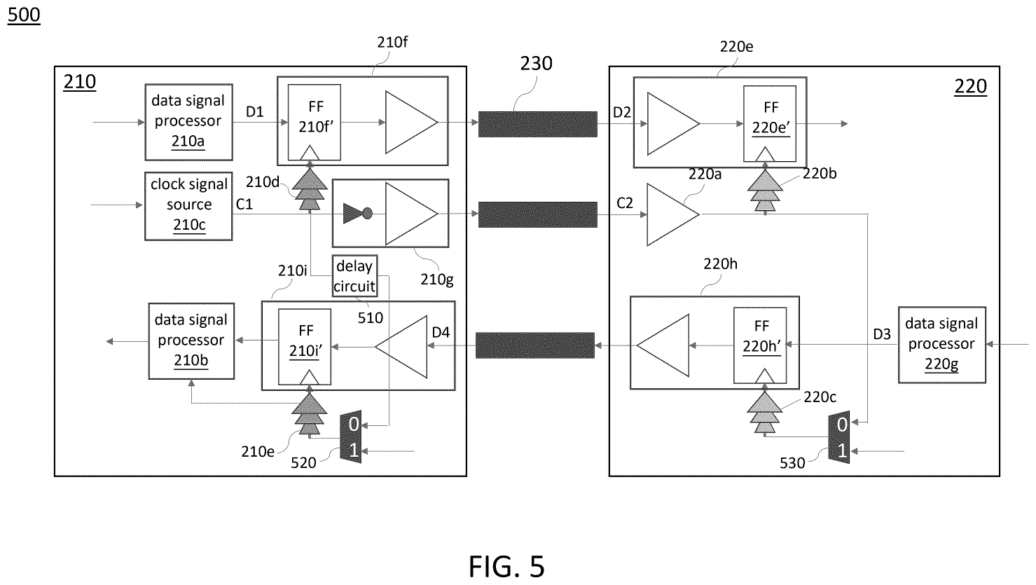

FIG. 5 is a circuit/block diagram of another exemplary system 500 in accordance with embodiments of the present disclosure. As illustrated in FIG. 5, the example system 500, e.g., system 100, differs from the system 400 in that the system 500 further includes a delay circuit 510 and first and second multiplexers 520, 530. The delay circuit 510 is connected between the clock signal (C1) source 210c and the multiplexer 520, introduces a propagation delay to the clock signal (C1), and generates a delayed version of the clock signal (C1). For example, the delay circuit 510 mimics the propagation delays of the clock signal (C1) transmitter 210g, the interconnects 230, and the clock signal (C2) receiver 220a. In this exemplary embodiment, the delay circuit 510 includes one or more inverters and/or one or more buffer circuits. Various configurations for the delay circuit 510 are contemplated in other embodiments.

The multiplexer 520, in response to a control signal (e.g., received from a control signal generator), selects the delayed version of the clock signal (C1) and forwards the selected delayed version of the clock signal (C1) to the data signal (D4) receiver 210i. For example, the multiplexer 520 has a first input terminal connected to the delay circuit 510, a second input terminal that is either floating or hard-wired to a logic state, e.g., 0 or 1, and an output terminal connected to the clock tree 210e. The multiplexer 530, in response to a control signal (e.g., received from a control signal generator), selects the clock signal (C2) and forwards the selected clock signal (C2) to the data signal (D3) transmitter 220h. For example, the multiplexer 530 has a first input terminal connected to the clock signal (C2) receiver 220a, a second input terminal that is either floating or hard-wired to a logic state, e.g., 0 or 1, and an output terminal connected to the clock tree 220c.

In an embodiment, the data signal (D4) receiver 210i is dispensed with the register circuit 210i″. In such an embodiment, the flip-flop circuit 210i′ may be replaced with a demultiplexer.

In an exemplary operation, the data signal (D1) processor 210a generates a data signal (D1) while the clock signal (C1) source 210c generates a clock signal (C1). In response to the clock signal (C1), the data signal (D1) transmitter 210f transmits the data signal (D1) to the semiconductor chip 220 as a data signal (D2). Meanwhile, the clock signal (C1) transmitter 210g sends the clock signal (C1) as a clock signal (C2) to the semiconductor chip 220.

The data signal (D2) receiver 220e then receives the data signal (D2) in response to the clock signal (C2). Next, the data signal (D3) processor 220g generates a data signal (D3). The data signal (D3) transmitter 220h, in response to the clock signal (C2), transmits the data signal (D3) to the semiconductor chip 210 as a data signal (D4). At this point, the delay circuit 510 generates a delayed version of the clock signal (C1). The data signal receiver 210i, in response to the clock signal (C1) and the delayed version of the clock signal (C1), receives the data signal (D4). Thereafter, the data signal (D4) processor 210b processes the data signal (D4).

From the above description, by virtue of the delay circuit 510 mimicking the propagation delays introduced by the clock signal (C1) transmitter 210g, the interconnects 230, and the clock signal (C2) receiver 220a, the propagation delay introduced by the delay circuit 310 is substantially equal to the sum of the propagation delays caused by these components 210g, 230, 220a. As a result, the arrival of the clock signal (C2) at the data signal (D3) transmitter 220h occurs at substantially the same time as the arrival of the delayed version of the clock signal (C1) at the data signal (D4) receiver 210i. This synchronization facilitates stable data communication between the semiconductor chips 210, 220. In certain embodiments, the clock signal (C1) reaches the data signal (D1) transmitter 210f substantially simultaneously with the delayed version of the clock signal (C1) reaches the data signal (D4) receiver 210i.

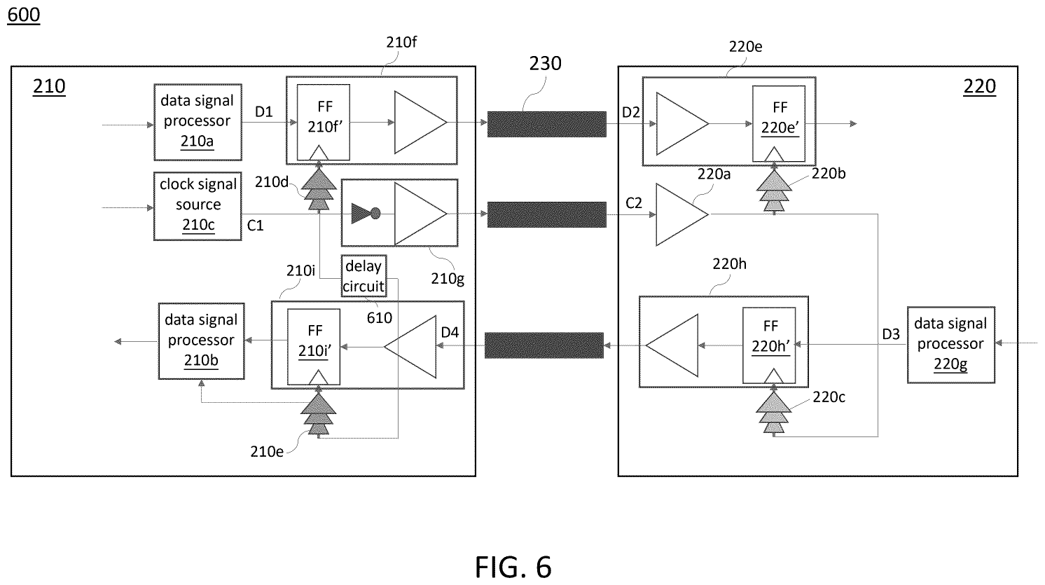

FIG. 6 is a circuit/block diagram of another exemplary system 600 in accordance with embodiments of the present disclosure. As illustrated in FIG. 6, the example system 600, e.g., system 100, differs from the system 400 in that the system 600 further includes a delay circuit 610 connected between the clock signal source 210c and the clock tree 210e, introduces a propagation delay to the clock signal (C1), and generates a delayed version of the clock signal (C1). For example, the delay circuit 610 mimics the propagation delays of the clock signal (C1) transmitter 210g, the interconnects 230, and the clock signal (C2) receiver 220a. In this exemplary embodiment, the delay circuit 610 includes one or more inverters and/or one or more buffer circuits. Various configurations for the delay circuit 610 are contemplated in other embodiments.

In an embodiment, the data signal (D4) receiver 210i is dispensed with the register circuit 210i″. In such an embodiment, the flip-flop circuit 210i′ may be replaced with a demultiplexer.

In an exemplary operation, the data signal (D1) processor 210a generates a data signal (D1) while the clock signal (C1) source 210c generates a clock signal (C1). In response to the clock signal (C1), the data signal (D1) transmitter 210f transmits the data signal (D1) to the semiconductor chip 220 as a data signal (D2). Now, the clock signal (C1) transmitter 210g sends the clock signal (C1) as a clock signal (C2) to the semiconductor chip 220.

Following this, the data signal (D2) receiver 220e receives the data signal (D2) in response to the clock signal (C2). The data signal (D3) processor 220g then generates a data signal (D3). The data signal transmitter 220h, in response to the clock signal (C2), transmits the data signal (D3) to the semiconductor chip 210 as a data signal (D4). At this time, the delay circuit 610 generates a delayed version of the clock signal (C1). The data signal receiver 210i, in response to the clock signal (C1) and the delayed version of the clock signal (C1), receives the data signal (D4). Thereafter, the data signal (D4) processor 210b processes the data signal (D4).

From the above description, by virtue of the delay circuit 610 mimicking the propagation delays introduced by the clock signal (C1) transmitter 210g, the interconnects 230, and the clock signal (C2) receiver 220a, the propagation delay introduced by the delay circuit 610 is substantially equal to the sum of the propagation delays caused by these components 210g, 230, 220a. As a result, the arrival of the clock signal (C2) at the data signal (D3) transmitter 220h occurs at substantially the same time as the arrival of the delayed version of the clock signal (C1) at the data signal (D4) receiver 210i. This synchronization facilitates stable data communication between the semiconductor chips 210, 220. In certain embodiments, the clock signal (C1) reaches the data signal (D1) transmitter 210f substantially simultaneously with the delayed version of the clock signal (C1) reaches the data signal (D4) receiver 210i.

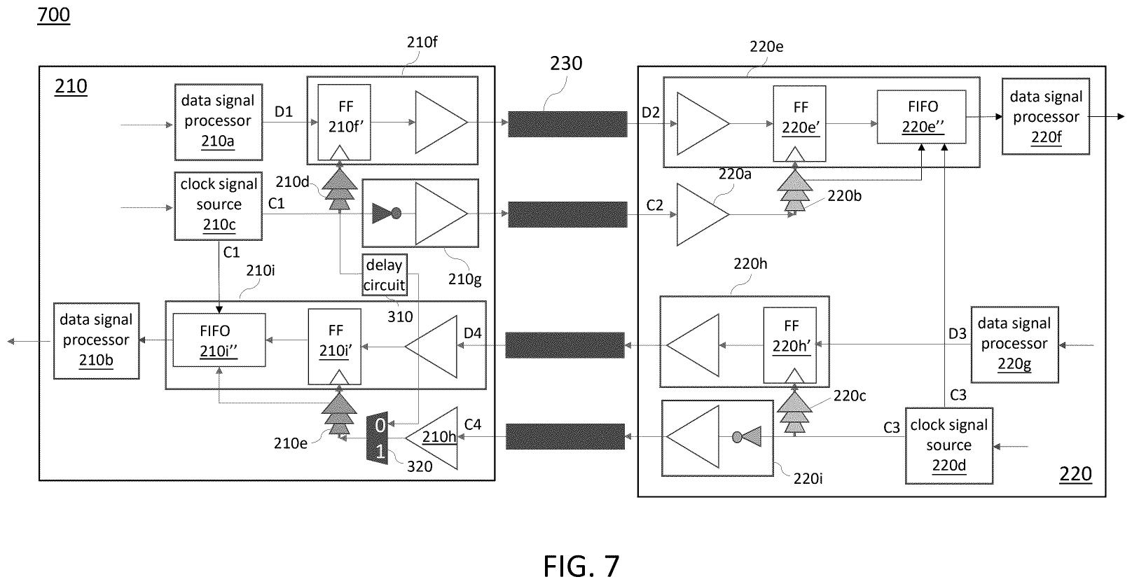

Various combinations of the semiconductor chips 210, 220 for systems 200-600 are contemplated in other embodiments. For example, FIG. 7 is a circuit/block diagram of another exemplary system 700 in accordance with embodiments of the present disclosure. As illustrated in FIG. 7, the example system 700, e.g., system 100, combines the semiconductor chip 210 from system 300 with the semiconductor chip 220 from system 200.

Because the operations of the semiconductor chip 210, 220 of system 700 are similar to those described above with respect to the semiconductor chip 210, 220 of system 200, 300, a detailed description of the same is dispensed herein for the sake of brevity.

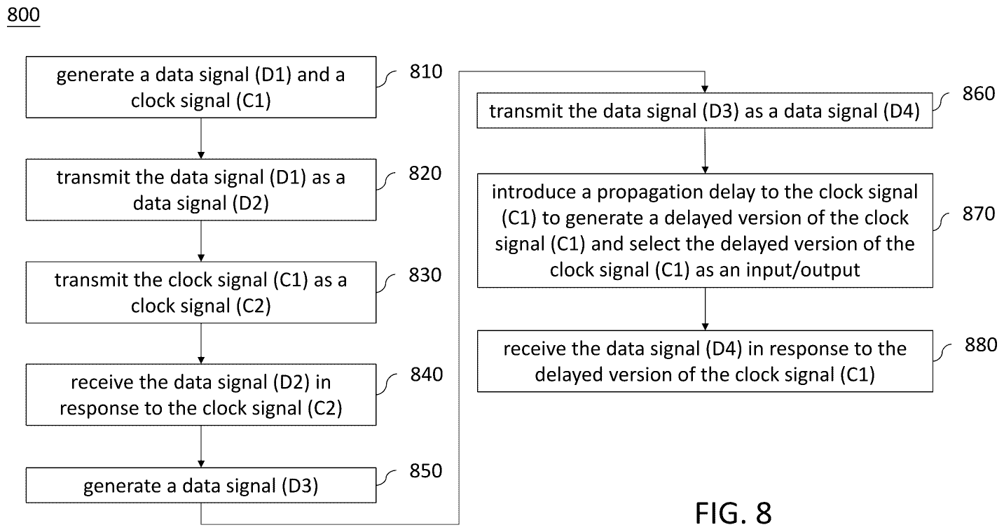

FIG. 8 is a flowchart of an exemplary method 800 of data communication between semiconductor chips in accordance with embodiments of the present disclosure. The example method 800 is described with further reference to FIGS. 1-7 for ease of understanding. It is understood that the method 800 is applicable to structures other than those of FIGS. 1-7. Further, it is understood that additional operations can be provided before, during, and after the method 800, and some of the operations described below can be replaced or eliminated, in an alternative embodiment of the method 800.

In operation 810, the data signal (D1) processor 210a generates a data signal (D1) while the clock signal (C1) source 210c generates a clock signal (C1). In operation 820, the data signal (D1) transmitter 210f, in response to the clock signal (C1), transmits the data signal (D1) to the semiconductor chip 220 as a data signal (D2). At this time, in operation 830, the clock signal (C1) transmitter 210g sends the clock signal (C1) as a clock signal (C2) to the semiconductor chip 220.

Subsequently, in operation 840, the data signal (D2) receiver 220e receives the data signal (D2) in response to the clock signal (C2). In operation 850, the data signal (D3) processor 220g then generates a data signal (D3). In operation 860, the data signal (D3) transmitter 220h, in response to the clock signal (C2), transmits the data signal (D3) to the semiconductor chip 210 as a data signal (D4).

Meanwhile, in operation 870, the delay circuit 310, 510 generates a delayed version of the clock signal (C1) and the multiplexer 320, 530, in response to a control signal, selects the delayed version of the clock signal (C1) as an input/output thereof. Thereafter, in operation 880, the data signal (D4) receiver 210i, in response to the clock signal (C1) and the delayed version of the clock signal (C1), receives the data signal (D4).

In an embodiment, a system comprises a plurality of semiconductor chips that are stacked on top of each other and that include first and second semiconductor chips. The first semiconductor chip includes a clock signal generating circuit, a transmitting circuit, and a receiving circuit. The clock signal generating circuit generates a clock signal and a delayed version of the clock signal. The transmitting circuit transmits a first data signal in response to the clock signal. The receiving circuit receives a second data signal in response to the delayed version of the clock signal. The receiving circuit receives the delayed version of the clock signal at substantially the same time that the transmitting circuit receives the clock signal.

In another embodiment, a semiconductor chip comprises a clock signal source, a data signal transmitter, a clock signal transmitter, and a data signal receiver. The clock signal source generates a first clock signal. The data signal transmitter transmits a first data signal in response to the first clock signal. The clock signal transmitter transmits the first clock signal. The data signal receiver receives a second data signal in response to a delayed version of the first clock signal or a second clock signal.

In another embodiment, a data communication method comprises: generating, by a first semiconductor chip, a first clock signal; in response to the first clock signal, transmitting a first data signal to a second semiconductor chip as a second data signal; sending the first clock signal as a second clock signal to the second semiconductor chip; receiving, by the second semiconductor chip, the second clock signal; in response to the second clock signal, transmitting a third data signal to the first semiconductor chip as a fourth data signal; and in response to a delayed version of the first clock signal, the first semiconductor chip receiving the fourth data signal.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system comprising:
a plurality of semiconductor chips stacked on top of each other and including first and second semiconductor chips, wherein the first semiconductor chip includes:
a clock signal generating circuit configured to generate a first clock signal and a delayed version of the first clock signal;
a transmitting circuit configured to transmit a first data signal in response to the first clock signal; and
a receiving circuit configured to receive a second data signal in response to the delayed version of the first clock signal, wherein the receiving circuit is configured to receive the delayed version of the first clock signal at substantially the same time that the transmitting circuit is configured to receive the first clock signal.

2. The system of claim 1, wherein the clock signal generating circuit includes:
a clock signal source configured to generate the first clock signal;
a clock signal transmitter configured to send the clock signal to the second semiconductor chip; and
a delay circuit connected between the clock signal source and the receiving circuit and configured to generate the delayed version of the first clock signal.

3. The system of claim 1, wherein the receiving circuit includes:
a clock signal receiver configured to receive a fourth clock signal;
a data signal receiver configured to receive a fourth data signal; and
a multiplexer having a first input terminal connected to the clock signal generating circuit, a second input terminal connected to the clock signal receiver, and an output terminal connected to the data signal receiver and configured to select one of the delayed version of the first clock signal and the fourth clock signal and to forward the selected one of the delayed version of the first clock signal and the fourth clock signal to the data signal receiver.

4. The system of claim 1, wherein the receiving circuit includes:
a data signal receiver configured to receive a fourth data signal; and
a multiplexer connected between the clock signal generating circuit and the data signal receiver and configured to select the delayed version of the first clock signal and to forward the selected delayed version of the first clock signal to the data signal receiver.

5. The system of claim 1, wherein the receiving circuit includes:
a data signal receiver configured to receive a fourth data signal; and
a delay circuit connected between the clock signal generating circuit and the data signal receiver and configured to generate the delayed version of the first clock signal.

6. The system of claim 1, wherein the clock signal generating circuit includes a delay circuit in the form of one or more inverters and/or one or more buffer circuits.

7. The system of claim 1, wherein the transmitting circuit (110b) includes:
a data signal processor configured to generate the data signal;
a clock signal source configured to generate the clock signal;
a data signal transmitter configured to transmit the data signal to the second semiconductor chip in response to the clock signal; and
a clock signal transmitter configured to transmit the clock signal to the second semiconductor chip.

8. The system of claim 1, wherein the second semiconductor chip includes:
a clock signal receiver configured to receive a second clock signal;
a clock signal source configured to generate a third clock signal;
a data signal receiver configured to receive a second data signal in response to the second and third clock signals;
a data signal transmitter configured to transmit a data signal;
a clock signal transmitter; and
a multiplexer having a first input terminal connected to the clock signal receiver, a second input terminal connected to the clock signal source, and an output terminal connected to a node between the data signal transmitter and the clock signal transmitter and configured to select one of the second and third clock signals and to forward the selected one of the second and third clock signals to the data signal transmitter and the clock signal transmitter.

9. The system of claim 1, wherein the second semiconductor chip includes:
a clock signal receiver configured to receive a second clock signal;
a data signal receiver configured to receive a second data signal in response to the second clock signal; and
a data signal transmitter configured to transmit a data signal in response to the second clock signal.

10. The system of claim 1, wherein the second semiconductor chip includes:
a clock signal receiver configured to receive a second clock signal;
a data signal receiver configured to receive a second data signal in response to the second clock signal; and
a data signal processor;
a data signal transmitter configured to transmit a data signal; and
a multiplexer connected between the clock signal receiver and the data signal transmitter and configured to select the second clock signal and to forward the selected second clock signal to the data signal transmitter.

11. The system of claim 1, wherein the second semiconductor chip includes:
a data signal processor configured to generate the data signal;
a clock signal source configured to generate the clock signal;
a data signal transmitter configured to transmit the data signal to the second semiconductor chip in response to the clock signal; and
a data signal processor configured to process the data signal.

12. A semiconductor chip comprising:
a clock signal source configured to generate a first clock signal;
a data signal transmitter configured to transmit a first data signal in response to the first clock signal;
a clock signal transmitter configured to transmit the first clock signal; and
a data signal receiver configured to receive a second data signal in response to a delayed version of the first clock signal or a second clock signal.

13. The semiconductor chip of claim 12, further comprising a delay circuit connected between the clock signal source and the data signal receiver and configured to generate a delayed version of the first clock signal, wherein the data signal receiver is configured to receive the second data signal in response to the delayed version of first clock signal.

14. The semiconductor chip of claim 12, further comprising:
a delay circuit connected to the clock signal source and configured to generate a delayed version of the first clock signal; and
a multiplexer connected between the delay circuit and the data signal receiver and configured to select the delayed version of the first clock signal and to forward the selected delayed version of the first clock signal to the data signal receiver, wherein the data signal receiver is configured to receive the second data signal in response to the delayed version of the first clock signal.

15. The semiconductor chip of claim 12, further comprising:
a delay circuit connected to the clock signal source and configured to generate a delayed version of the first clock signal;
a clock signal receiver; and
a multiplexer having a first input terminal connected to the delay circuit, a second input terminal connected to the clock signal receiver, and an output terminal connected to the data signal receiver and configured to select one of the delayed version of the first clock signal and the clock signal and to forward the selected one of the delayed version of the first clock signal and the clock signal to the data signal receiver.

16. A data communication method comprising:
generating, by a first semiconductor chip, a first clock signal;
in response to the first clock signal, transmitting a first data signal to a second semiconductor chip as a second data signal;
sending the first clock signal as a second clock signal to the second semiconductor chip;
receiving, by the second semiconductor chip, the second clock signal;
in response to the second clock signal, transmitting a third data signal to the first semiconductor chip as a fourth data signal; and
in response to a delayed version of the first clock signal, the first semiconductor chip receiving the fourth data signal.

17. The method of claim 16, further comprising receiving, by a data signal receiver of the first semiconductor chip, the delayed version of the first clock signal at substantially the same time as receiving, by the data signal receiver of the second semiconductor chip, the second clock signal.

18. The method of claim 16, further comprising generating the delayed version of the clock signal by mimicking propagation delays of the first and second semiconductor chips.

19. The method of claim 16, further comprising selecting, by a multiplexer of the first semiconductor chip, the delayed version of the first clock signal and forwarding the delayed version of the first clock signal to a data signal receiver of the first semiconductor chip.

20. The method of claim 16, further comprising introducing a propagation delay to the first clock signal substantially equal to a sum of a propagation delay introduced by the first and second semiconductor chips.
